(19) United States
(12) Patent Application Publication
(10) Pub. No.: US 2025/0315015 A1
(43) Pub. Date: Oct. 9, 2025

(54) IOT/SMART DEVICE CONTROL FROM STB USING EDGE AI CONTENT

(71) Applicant: DISH Network Technologies India Private Limited, Bengaluru (IN)

(72) Inventors: Mansoor Ahmed, Bengaluru (IN); Rajesh Govindu, Bengaluru (IN); Prasanna Kumar L, Bengaluru (IN)

(21) Appl. No.: 18/791,026

(22) Filed: Jul. 31, 2024

(30) Foreign Application Priority Data
Apr. 8, 2024 (IN) 202441028657

(51) Int. Cl. G05B 13/02

(52) U.S. Cl. CPC G05B 13/0265

(57) ABSTRACT

The disclosed technology provides a system and methods for receiving, by a computing device, data indicating an action to be performed. The computing device may provide at least a portion of the data to the machine learning model configured to determine an IoT device associated with the action to be performed using the portion of the data. The computing device may receive from the machine learning model, an output from the machine learning model, the output indicating the IoT device associated with the action to be performed. The computing device may determine and/or generate a control signal configured to cause the IoT device to perform the action. The computing device may transmit the control signal to the IoT device.

### CROSS REFERENCE TO RELATED APPLICATIONS

This application claims priority to Indian Provisional Patent Application Serial No. 202441028657, filed on Apr. 8, 2024, in the Indian Intellectual Property Office, the disclosure of which is incorporated by reference in its entirety for all purposes.

### BACKGROUND OF THE INVENTION

The field of home automation has experienced rapid growth with the advent of the Internet of Things (IoT). In modern smart homes, a myriad of devices, ranging from lighting and HVAC systems to security and kitchen appliances, can be controlled remotely and automated to improve convenience, energy efficiency, and security. Typically, these IoT devices are interconnected through a home network and managed via various platforms, including smartphones, tablets, or dedicated hubs. The control and interoperability of IoT devices (e.g., smart home devices) often relies on backend servers and cloud computing solutions, which introduce limitations related to the integrated control of IoT devices.

### BRIEF SUMMARY OF THE INVENTION

Aspects of the disclosed technology include a system of one or more computers that may be configured to perform particular operations or actions by virtue of having software, firmware, hardware, or a combination of them installed on the system that in operation causes or cause the system to perform the actions. One or more computer programs may be configured to perform particular operations or actions by virtue of including instructions that, when executed by data processing apparatus, cause the apparatus to perform the actions.

Aspects of the disclosed technology may include a method for controlling an Internet of Things (IoT) device. The method may include receiving, by a computing device, data indicating an action to be performed; providing, by the computing device to a machine learning model, at least a portion of the data, the machine learning model configured to determine an IoT device associated with the action to be performed using the portion of the data; receiving, by computing device from the machine learning model, an output from the machine learning model, the output indicating the IoT device associated with the action to be performed; determining, by the computing device a control signal configured to cause the IoT device to perform the action; and transmitting, by the computing device, the control signal to the IoT device. Additional aspects of the disclosed technology include corresponding computer systems, apparatus, and computer programs recorded on one or more computer storage devices.

Aspects of the disclosed technology may include one or more of the following features. The method may include the machine learning model being executed locally on the computing device. Determining the control signal may be performed by the machine learning model. The machine learning model may be executed on a remote server. The method may include receiving, by the computing device, user feedback indicating an accuracy of the output from the machine learning model; and providing, by the computing device, at least one of the output from the machine learning model or the use feedback such that the machine learning model is retrained. The user feedback may be provided to a server and the retraining occurs at the server. The method may include detecting, by the computing device, a change associated with the IoT device or additional IoT devices; transmitting, by the computing device, data indicating the change to a server; receiving by the computing device, a training data from the server the training data associated with the change; and providing, by the computing device, the training data to the machine learning model such that the machine learning model is retrained. The method may include determining, by the machine learning model of the computing device, one or more sub-actions related to the action to be performed; determining, by the machine learning model, the IoT device or additional IoT devices associated with the one or more sub-actions; and generating, by the machine learning model, the output from the machine learning model to indicate the IoT device or the additional IoT devices. The method may include for each of the IoT device or the additional IoT devices indicated in the output from the machine learning model: determining, by the computing device, a respective control signal configured to cause a respective IoT device to perform associated sub-actions; and transmitting, by the computing device, the respective control signals to the respective IoT devices. The method may include receiving, by the computing device, a status update from the IoT device after executing the action; and causing, by the computing device, a confirmation or result of the action to be displayed. The method may include retraining the machine learning model based on receiving, at the computing device, a new capability of the IoT device. Data indicating the action to be performed is a voice command. Implementations of the described techniques may include hardware, a method or process, or computer software on a computer-accessible medium.

Aspects of the disclosed technology may include a non-transitory computer-readable medium containing instructions. The non-transitory computer-readable medium containing instructions may also include receiving, by a computing device, data indicating an action to be performed; providing, by the computing device to a machine learning model, at least a portion of the data, the machine learning model configured to determine an IoT device associated with the action to be performed using the portion of the data; receiving, by computing device from the machine learning model, an output from the machine learning model, the output indicating the IoT device associated with the action to be performed; determining, by the computing device a control signal configured to cause the IoT device to perform the action. The instructions may also include transmitting, by the computing device, the control signal to the IoT device.

Aspects of the disclosed technology may include one or more of the following features. A non-transitory computer-readable medium containing instructions may allow the machine learning model to be executed on a remote server. The non-transitory computer-readable medium containing instructions may include receiving, by the computing device, user feedback indicating an accuracy of the output; and providing, by the computing device, at least one of the output or the use feedback such that the machine learning model is retrained.

Aspects of the disclosed technology may include a system. The system may include a computer readable medium may include instructions that, when executed by the one or more processors, cause the system to perform operations to: receive, by a computing device, data indicating an action to be performed; provide, by the computing device to a machine learning model, at least a portion of the data, the machine learning model configured to determine an IoT device associated with the action to be performed using the portion of the data; receive, by computing device from the machine learning model, an output from the machine learning model, the output indicating the IoT device associated with the action to be performed; determine, by the computing device a control signal configured to cause the IoT device to perform the action. The system may include transmit, by the computing device, the control signal to the IoT device.

Aspects of the disclosed technology may include one or more of the following features. The system may include instructions that when executed cause the system to perform operations to display an error message when the machine learning model is unable to determine the output. The system may include instructions that when executed cause the system to perform operations to display, one or more options displayed, the one or more options indicating user inputs to resolve the error message. The system may include instructions that when executed cause the system to perform operations to receive at least one user input responsive to the one or more options to resolve the error message. The system may include instructions that when executed cause the system to perform operations to retrain the machine learning model based on the user input responsive to the one or more options to resolve the error message. Implementations of the described techniques may include hardware, a method or process, or computer software on a computer-accessible medium.

### BRIEF DESCRIPTION OF THE DRAWINGS

FIG. 1 illustrates a system 100 and a process 101 related to controlling IoT devices on a local network according to aspects of the disclosed technology.

FIGS. 2A-2C various aspects related to controlling IoT devices according to aspects of the disclosed technology.

FIG. 3 relates to a training process of a machine learning algorithm according to aspects of the disclosed technology.

FIG. 4 depicts an example method according to aspects of the disclosed technology.

FIG. 5 is a schematic of an example computer system according to aspects of the disclosed technology.

### DETAILED DESCRIPTION OF THE INVENTION

### Overview

The control and interoperability of IoT devices (e.g., smart home devices) often relies on backend servers and cloud computing solutions. Such devices, when controlled through a user input (e.g., a voice input or text) may require user commands or inputs to be processed at a remote server. The remote server may be a server which is not located locally within a local network of the IoT devices. The remote server may then send results back to the local network, such as a computing device on the local network, and/or the IoT device(s) to take the appropriate action responsive to the user input provided.

This dependency on processing at a remote location (e.g., the remote server) introduces several challenges. First, the necessity for a consistent internet connection creates inherent vulnerabilities, such as service interruptions due to network outages. Second, the transmission of user data to and from the cloud raises concerns regarding user privacy and data security. In an era where data breaches are becoming increasingly common, the transmission of potentially sensitive information to remote servers poses a significant risk. Further, the size of artificial intelligence and machine learning models may grow larger on server devices as the complexity of the models grows. The server may require additional elements to improve security and/or privacy.

Furthermore, the reliance on cloud-based infrastructure often results in noticeable latency between a user's command and the device's response, which can detract from the user experience. As the number of IoT devices within a household grows, the demand on network bandwidth and backend processing increases, potentially exacerbating these issues. As one example, if a user provides input which indicates that the user is leaving his house, this information may potentially be intercepted if it leaves the local network, leading to unscrupulous elements taking advantage of the user input for nefarious means. Thus, there remains a significant challenge in providing a system that can efficiently and securely manage these devices, while maintaining user privacy.

Aspects of the disclosed technology include the integration and management of Internet of Things (IoT) devices within a smart home environment, utilizing a computing device (e.g., a set-top box (STB)) as a centralized control unit. The disclosed technology may enhance user experience by providing efficient, voice-based (or other user input) control over home IoT devices through the computing devices. The computing device may serve as an intelligent hub connected to a local home network. By employing an “edge AI” within the computing device, the technology enables processing of user commands and device control locally. This may minimize latency and reduce reliance on cloud services and remove the necessity of internet connectivity. An edge AI model may refer to the deployment of artificial intelligence algorithms or machine learning models which may be run directly on devices located at the edge of the network, rather than processing data in centralized data centers or cloud environments. In other words, an edge AI model may run without transmitting data to and from a central server, keeping sensitive data locally, decreasing a risk of exposure of sensitive data. As an example, an “edge” devices can include smartphones, IoT devices like smart thermostats or security cameras, and industrial machines, among others. An edge device may refer to a device which may be connected within a local network. The key characteristic of “edge AI” may include its ability to process and analyze data locally on the device itself.

One aspect of the disclosed technology may allow for a dynamic and adaptive machine learning models within the computing device, capable of learning and evolving with the user's habits and the addition of new devices. The computing device, through its machine learning capabilities (e.g., edge AI capabilities), can receive user inputs in various forms, including voice inputs and visual inputs. The computing device may process those inputs to interpret the user's intent. The intent may be outputted as a list of actions to be taken by IoT devices. Control signals which correspond to the list of actions may be generated for each IoT device.

Furthermore, the disclosed technology may provide for enhanced privacy and security by keeping the user's data and device management tasks within the confines of the local network, without the need for transmitting sensitive information over the internet. This approach not only safeguards user privacy but also ensures uninterrupted functionality in the event of internet downtime.

Aspects of the disclosed technology include updating or modifying the machine learning model (e.g., an edge AI model) either locally or via cloud-based services, to adapt to new IoT devices or changing functionalities of existing devices. This may ensure that the computing device's ability to manage the smart home ecosystem remains current. An update to the machine learning model may include replacing the model with a new version of the model.

Aspects of the disclosed technology may include the flexibility to adapt the machine learning model's size to the computing device's processing capacity, ensuring optimal performance and scalability of a feature set. Aspects of the disclosed technology also include choosing a most suitable model to be stored on a computing device based on characteristics of the user device.

### Example Systems and Methods

The following examples illustrate various embodiments of the disclosed technology, aligned with the figures previously described, offering a detailed view of how the system operates within various settings.

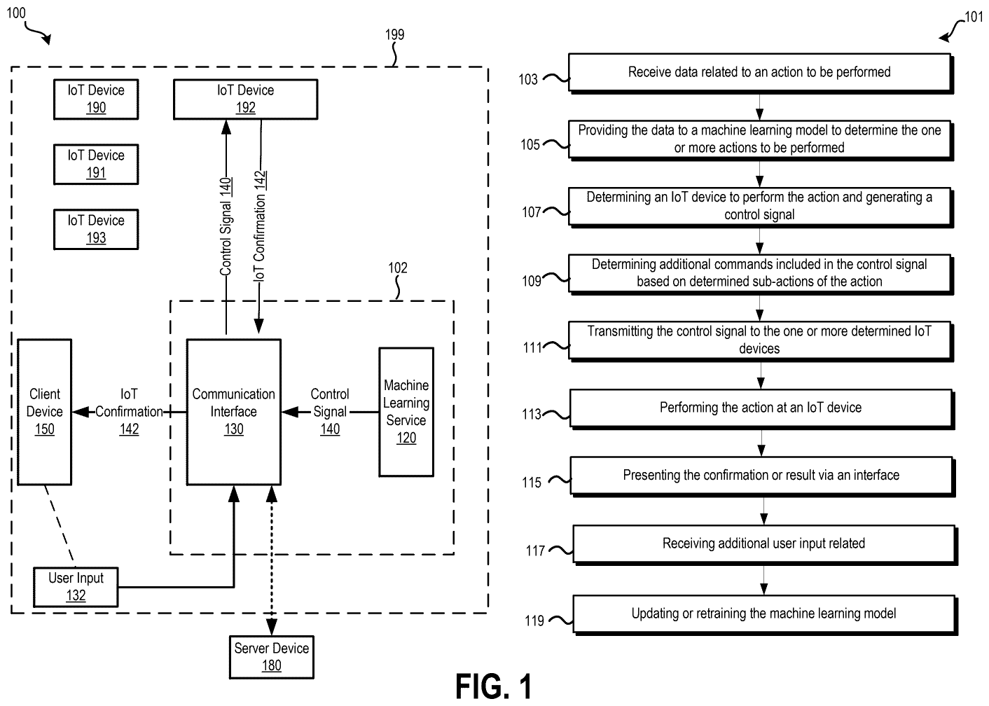

FIG. 1 illustrates a system 100 and a process 101 related to controlling IoT devices on a local network, according to certain embodiments. System 100 may include a computing device 102, a client device 150, and IoT devices 190-193. System 100 may further include a server device 180. The computing device 102 may include a machine learning service 120 and a communication interface 130. In some examples, portions of the system 100 may be connected and form a local network (e.g., network devices which connect with one another and/or amongst one another through a central node) while other components of the network may be located outside of the local network (e.g., the server device 180).

The computing device 102 may include one or more computing devices which contain hardware and/or software to perform the functions described herein. The computing device 102 may be any combination and may include, for example, one or more databases, modules, computational units, and communication interfaces. The computing device 102 may include a machine learning (ML) service 120 and a communication interface 130. Further, the computing device 102 may include a Central Processing Unit (CPU), which may execute operating system and application instructions, process user inputs, and manage communications. It may also include other processing devices, such as for example, a Neural Processing Unit (NPU), which may be configured to execute AI algorithms (e.g., as voice command recognition and user behavior analysis). The computing device 102 may further include memory and storage units, such as for example, RAM for temporary data access, solid-state drives (SSDs) and/or hard disk drives (HDDs) for long-term storage (e.g., for storing the operating system, applications, and user data).

The communication interface 130 may support and/or include one or more standards which may enable communication between devices. The communication interface 130 may include wireless and wired communication. The wireless communication capabilities of the communication interface 130 may include Wi-Fi, Bluetooth, NFC, infrared, various other radio frequencies, etc. Communication interface 130 may include wired communication capabilities, such as USB, Ethernet, HDMI, co-axial cables, etc. The communication interface 130 may allow communication with the client device 150 between and amongst the one or more of the IoT devices 190-193.

Machine learning service 120 may include one or more machine learning models (MLMs). For example, the ML service 120 may include a natural language processor (NLP) model. The NLP model may be used to analyze audio information from the underlying content and/or speech obtained from the client device 150 and/or the computing device 102. The NLP model may include technology to facilitate the interaction between humans and computers. For instance, the NLP may include algorithms that may convert an input (e.g., human voice providing a command) to inputs interpretable by a computer by converting the voice to text, parsing the text, analyzing the text, and deciphering intent from the text. Similarly, an output from a computer may be transformed into an output which is interpretable by a human by creating sentences from an output (e.g., as a notification on a user device which states that a certain command has been performed). The NLP model may also contain other software and/or hardware which may allow for conversion of speech to text, such as specific machine learning models to perform the conversion. Other example machine learning models discussed herein may also be included in the machine learning service 120.

In some examples, the machine learning service 120 may include an edge AI model. The edge AI model may be chosen from a set of models. The specific edge AI model included and/or executed on the machine learning service 120 may be the based on a set of IoT devices registered and/or in communication with the computing device 102. The specific edge AI model chosen may thus one has outputs which correspond to the IoT devices which have been registered on the local network formed with the computing device 102. Selection of the edge AI model in this manner may allow the model to be of a smaller size and of reduced complexity. Further, the edge AI model may be stored and/or chosen based on the current version of software on IoT devices connected with the computing device 102. A change to a version of the software of an IoT device may further ensure that changing variations of an IoT device or updates to software may be reflected in a new IoT device. Thus, IoT devices from various generations or with proprietary communication standards can be integrated and controlled through the computing device 102. This capacity for protocol translation may allow for flexibility and forward-compatibility of the computing device 102 and the system 100.

The client device 150 may be any device which may be capable of receiving input and/or providing an output to a user. For example, the client device 150 may be a set top box, a tablet, a smart TV, a smartphone, smart watch, a smart device, a tablet device, a mobile device, and/or other user device. The client device 150 may contain a communication interface which may allow it to communicate with the computing device 102. This may include other peripheral input devices, such as a TV remote, Bluetooth keyboard, camera, microphones, etc.

IoT devices 190-193 may be internet of things devices For example, the IoT devices 190-193 may include home lighting, smart bulbs, HVAC systems, security systems, kitchen appliances (e.g., microwaves, blenders, coffee makers, refrigerators, dishwasher), washing machines, etc. The IoT devices 190-193 may further be connected to one or more other devices on a home network (e.g., via a home Wi-Fi network) or through another communication interface. In some examples, the IoT devices 190-193 may also have the capability to connect to other, remote servers and/or computing systems through the internet. However, in other examples, such as when privacy may be required, The IoT devices 190-193 may only communicate via a local network.

Each of the IoT devices may include a combination of hardware and/or software to carry out a specific function. For example, a dishwasher may have the capability of washing dishes in various wash settings, drying the dishes, sound settings etc. A security system may have the ability to arm and disarm multiple areas of a home. A washing machine may have various wash cycles. A heating system or cooling system may have various temperature ranges possible. A smart blind system may have various levels of “open” or “close” to allow a certain amount of light to enter through the blinds. One of ordinary skill in the art would recognize many different such IoT devices.

The IoT devices 190-193 may be integrated with computing device 102 through the use of “matter protocol.” “Matter protocol” may serve as a universal language for smart home devices, allowing for interoperability across different manufacturers and ecosystems. Matter protocol may allow the computing device 102 to act as a centralized control point, from which other the IoT devices 190-193 can be managed and controlled. Matter protocol may allow for communication with IOT devices regardless of a native protocol which may be present on an IoT device. In some examples, such as for IoT devices that are not natively compatible with the Matter protocol, the machine learning service 120 may be used to translate non-standard protocols into a form that is understandable by the computing device 102 to bridge communication between disparate IoT technologies.

The server device 180 may be a server to which the computing device 102 may be in data communication with. The server device 180 may include one or more computing devices, including servers and databases, which may operate collectively as a server. In some examples, the server device 180 may include a cloud computing environment or be instantiated on a cloud computing environment. The server device 180 may provide software updates to the computing device 102. For example, the server device 180 may provide firmware updates to the computing device 102, provide other algorithms (e.g., machine learning models), and other such updates.

At 103, the computing device 102 may receive data related to an action to be performed. This information may be, for example, a user input 132. The user input 132 may be provided as a voice command. In some examples, the user input 132 may be provided as textual information which may be provided through a keyboard to a user interface of the client device 150 configured to receive user input. This may include a chatbox through which a user can provide a string of text which can be interpreted by the computing device 102. In other examples, the user data 132 may include voice data. For example, a user may state “prepare the basement and start the wash.” An audio file may be created which represents the user data 132.

At 105, the received data related to the action to be performed can be provided to a machine learning model and/or analysis model, such as for example, a machine learning model stored within the machine learning service 120. The data may be analyzed by the machine learning model and/or analysis model to determine one or more action to be performed based on the data. For example, using the example provided above with respect to 103, the one or more actions may be determined to be turning on lights, the climate control, and to start a washing process. These may be actions which may later be broken into sub actions. As another example, the voice command provided may be related to turning on the basement lights (e.g., I am going to the basement). Based on this, the machine learning service may determine that turning on the basement lights is an action to be performed.

At 107, one or more IoT devices to perform the action may be determined and one or more control signals may be generated for each IoT device. For example, a command may have been provided which relates to turning on the basement lights (e.g., a voice command saying “I am going to the basement” “turn on the downstairs lights” “going down the stairs” etc.). A control signal 140 may be generated by the machine learning service 120 (e.g., based on at least part of the command). For example, the machine learning service 120 may determine that turning on a light may involve the smart lights which are known to be located in the basement. The climate control may include turning on the climate control which may be located or associated with the basement. The IoT device associated with washing may be determined to be the washing machine. The washing machine may be determined rather than another IoT device based on context clues (e.g., washing machines being in the basement) rather than another washing process (e.g., the dishwasher). A control signal may also be generated at the computing device 102 for each of the actions. Each control signal may correspond to a determined IoT device for the action. For instance, a control signal to “turn on” may be generated for the smart light IoT device. A control signal to “cool” may be generated for the climate control IoT device. Similarly, a control signal to “wash” may be generated for the washing machine.

At 109, sub-actions related to the action may be determined and additional commands may be generated in the control signal based on determined sub-actions of the action. For example, the “turn on” command may include sub actions related to the intensity of the light. The “cool” action may include a fan speed, a temperature setting, or other information related to the climate control. A wash signal may include the temperature, wash speed, or additional rinse settings. Other sub-actions may be performed later in time (e.g., turning off the climate control after a set period of time).

At 111, the control signal may be transmitted from the communication interface 130 of the computing device 102 to one or more IoT devices (e.g., IoT device 192). Although only a signal control signal is illustrated in FIG. 1 as being transmitted from the communication interface 130, a control signal may be transmitted for each IoT device. For example, the control signal to “turn on” may be transmitted to the smart light IoT device. The control signal to “cool” may be transmitted to the climate control IoT device. Similarly, the control signal to “wash” may be transmitted to the washing machine IoT device.

At 113, the action may be performed at the IoT device based on the control signal. For example, IoT device 192 may perform an action (and sub-actions) based on the information contained within the control signal 140. Referring to the examples provided above, the “cool” control signal generated for the climate control IoT device may include sub-actions such as “turn on fan,” “check current temperature,” “set a current temperature,” “change temperature after 4 hours” “override default settings” etc. Similarly, the control signal to “wash” which may be generated for the washing machine may have sub-actions such as “turn on water heater” “prewash the clothes” “set a rinse speed.” Additionally, the control signal 140 may be formatted to be compatible with the particular IoT device if a proprietary format and/or protocol is being used. For example, the control signal 140 may be formatted, configured, and/or structured according to the particular IoT device for which it is directed (e.g., the washing machine or the climate control device). After the action is performed, or the action is confirmed to be received by the IoT device 192, the IoT device 192 may provide a confirmation message, such as IoT confirmation 142. If the IoT device 192 is unable to perform the actions based on the control signal 140, it may provide an alternative message, such as an error message that the command is invalid or that it is unable to perform the command (due to, for example, a malfunction with the IoT device 192).

At 115, information related to the action may be presented to the user through an interface. For example, the IoT confirmation 142 may be transmitted from the computing device 102 to the client device 150. The client device 150 may, through one or more interfaces, present the results of the initial command to the user. This may include presenting the information on a display (e.g., a TV or other display), through audio (e.g., through speakers), or any other suitable method. In some examples, the computing device 102 may present the information in a format most suitable and/or preferred by the user for presentation to the user. In some examples, the IoT confirmation may contain other information formatted as another message (e.g., an error message, a list of options, a request for additional user input).

At 117, additional information may be provided by the user as additional user input. This may be used to disambiguate or decide between potential options for actions and/or IoT devices when an action may correspond to multiple devices. For example, the action of “wash” may correspond to a dishwasher, a washing machine for clothes, or to a pet washing station. For example, the message “what type of wash do you mean” may be displayed on an interface. The message may also be generated based on the information in the machine learning service 120. The user may provide additional input to respond to that message. This may allow the machine learning model to determine an IoT device and an action. Additional messages such as “do you have delicate clothes?” may be displayed for the user to respond to, which may be used by the computing device and/or the machine learning service 120 to further create sub-actions related to the action.

At 119, the machine learning model may be updated, customized, and or retrained. In some examples, this may occur based on the additional user input received in 117. The updating may allow user preferences to be known and/or to group certain activities together that the user performs. In some examples, time information related to the user input may be used to determine which IoT device may be associated with a user input based on the time of day. In some examples, the retraining may include adjusting weights and/or other inputs relate to a language model which may be used to extract and/or interpret intent.

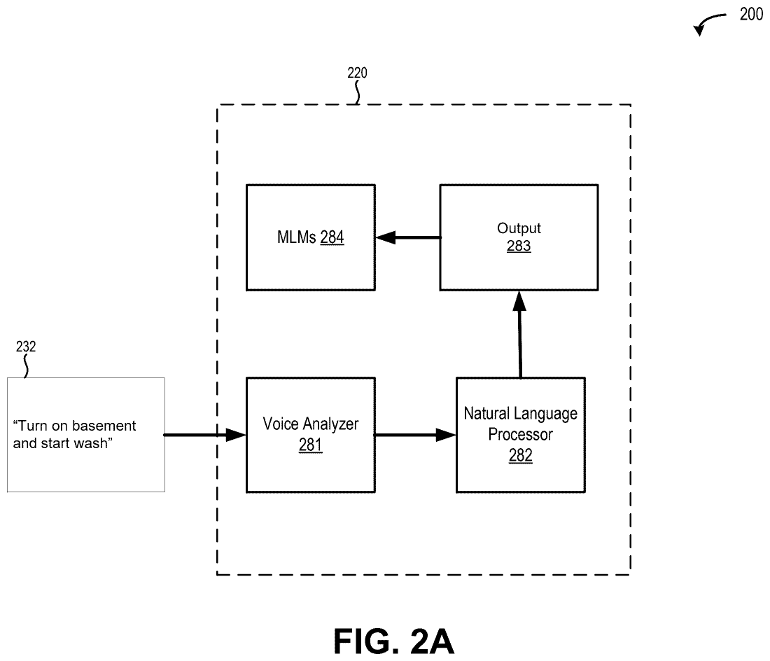

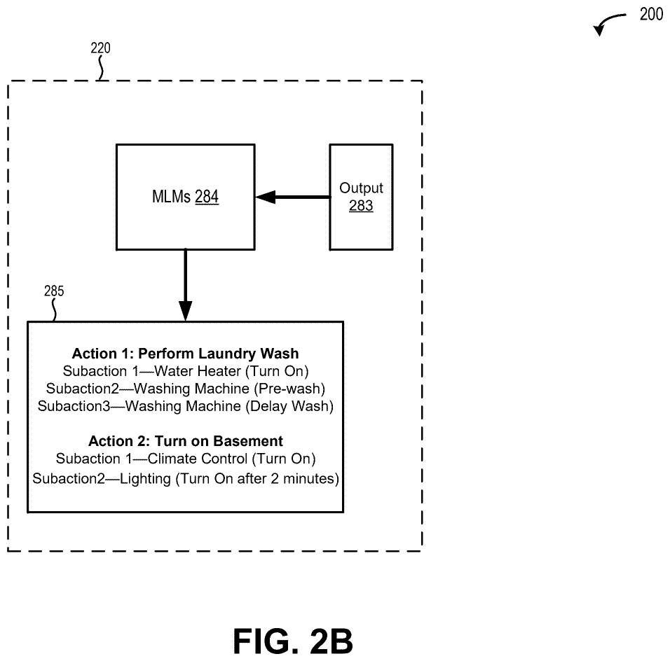

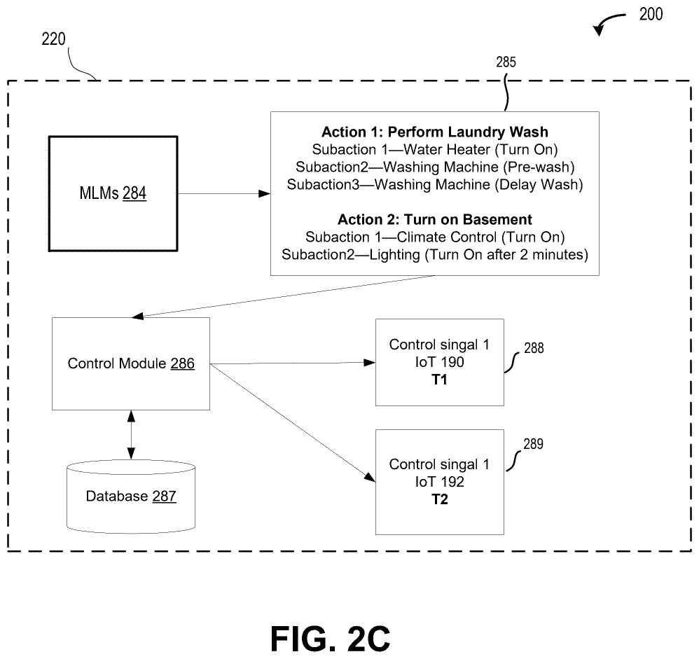

FIGS. 2A-2C illustrate aspects of a system 200 for controlling one or more IoT devices based on user input according to embodiments of the disclosed technology. The system 200 may be similar to some or all of the system 100 described in FIG. 1. Thus, the system 200 may include a machine learning service 220 (similar to the machine learning service 120), implemented on a computing device (e.g., the computing device 102). The machine learning service 220 may also be in communication (directly and/or indirectly) with other devices such as a client device (e.g., the client device 108, the IoT device 190-193, etc.). As shown in FIG. 2A, the machine learning service 220 may include a voice analyzer 281, a natural language processor (NLP) 282, an output 283, and machine learning models (MLMs) 284. The machine learning service 220 may receive a user input 232, which may be similar to the user input 232. The machine learning service 220 may receive a user input 232. The user input 232 may be similar to the user input 132, and be provided as via text or via a voice command. As one example, the user input 232, whether provided textually or orally, may be “prepare the basement and start the wash.”

In some examples, the user input 232 may be provided as textual information. This textual information may be provided through any suitable user device (e.g., through a keyboard to a user interface of a user device configured to receive user input). A user interface may also be used to indicate the textual information being inputted by the user (e.g., a display, a chatbox (e.g., an AI powered chatbox), e.g.). The textual information may thus be through which a user can provide a string of text which can be interpreted by the system 200. In some examples, and as further explained below, the textual information received as part of the user input 232 may transmitted to natural language processor 282 of the machine learning service 220 without being transmitted to the voice analyzer 281.

In some examples, the user input 232 may be provided through a voice command or other audio command. The voice command may be received at any suitable user device. The user input 232 may be audio information in which a user states “turn on basement and start wash.” The audio information may be provided as a message and/or file to the machine learning service 220. In some examples, the message may first be received by a communication interface (e.g., the communication interface 130) which may be in data communication with the machine learning service 220. The voice analyzer 281 may receive the user input 232 when provided through an auditory format.

Voice analyzer 281 may be any combination of hardware and/or software configured to identify, extract, and/or process language, from an audio sample, text, etc. (e.g., the user input 232). The voice analyzer 281 may contain filters to remove background noise or other unwanted noise from an audio sample which may be received. This may include spectrum subtraction (e.g., removing noise spectrum), adaptive filtering (algorithms to adjust and filter out noise). The voice analyzer 281 may be capable of language recognition and voice recognition, including the ability to convert audio to text (e.g., by using automatic speech recognition models and/or other language models). In some examples, the models may improve the accuracy based on the context and/or probability of word sequences. In some examples, the voice analyzer 281 may include the ability to detect emotion, pitch, and other elements of speech. In some examples, the voice analyzer 281 may also include the ability to identify a language being spoken and provide the audio to text in that manner. This may allow for the user input 232 to be provided in multiple languages. In some examples, the user input 232 may be in a language which is different from the language which has been used to train the machine learning service 230 and/or the MLMs 284. In such examples, the voice analyzer 281 may translate the auditory information received as part of the user input 232 into a language which is used by the machine learning service 230. The voice analyzer may output a string of text by extracting the audio information and provide that information to the natural language processor 282.

Natural language processor (NLP) 282 may be a processing service used to interpret, understand, and or modify language to allow the user input 232 to be interpretable by other components of system 220 (e.g., MLMs 284). In some examples, the NLP 282 may receive the user input 232 directly (e.g., when the user input 232 is provided as textual information). In other examples, the NLP 282 may receive an input from the voice analyzer 281 after it analyzes audio. The voice analyzer 281 may transform the audio into a string of text that is provided to the NLP 282.

The NLP 282 may tokenize the text by splitting the string of text into individual words, phrases, and/or elements. For example, in the particular example provided, the text may be split into “turn on,” “basement,” “start,” and “wash.” A portion of the split text may be referred to as a token. The tokens may be tagged with other information, such as grammatical properties (e.g., noun, verb, adjective, etc.) Other information related to the text may be determined and tagged and/or otherwise associated with the text, such as names, locations, source of text, category of grammar, entities, etc. The NLP 282 may further also parse the textual information to interpret and/or assign a grammatical structure to the text to discover a relationship between the words and/or phrases. For example, the “turn on” may be related to “basement” and “start” to “wash.” The NLP 282 may further include provide other representations of the textual information, such as a syntax tree. The NLP 282 may also be able to synthesize or add additional information to a string of text that it receives to provide additional information which may be used as by one or more of the MLMs 284. The output of the NLP 282 may provided as the output 283, which may be stored in the memory of a computing device (e.g., the computing device 102). The output 283 may be used by the MLMs 284 for further analysis. In this manner, the NLP 282 may interpret natural language and transform natural language into a format which is interpretable by MLMs 284.

FIG. 2B illustrates additional aspects of the system 200 and the machine learning service 220. The output 283 may be provided to the MLMs 284. MLMs 284 may include one or more machine learning models which may be used to analyze the output 283 and generate one or more actions related to one or more IoT devices (e.g., IoT devices 190-193). For example, the MLMs 284 may be configured to receive a textual string as an input and provide as an output one or more actions related to one or more IoT devices. In another example, the MLMs 284 may be configured to receive tokens derived from the user input 232. Other variations of the input for the MLMs 284 may be used. For example, time information, location information, source of user input 232, history of previous commands, etc. may all be information which may be provided to the MLMs 284.

The MLMs 284 may also provide one or more actions for each IoT device outputted, such as an action list 285. Each action within the action list 285 may further contain one or more actions. In some examples, an action may be a general category which may relate to a human-contextual action (e.g., wash laundry, active security system, turn on basement) while sub-actions may relate to specific IoT devices and specific steps (or sub-steps) which may be taken to undertake that action. Turning back to the specific example, the MLMs 284 may identify information from the output 283 to generate a specific action to be undertaken by the IoT devices based on keywords, such as “basement” “wash” “turn on” etc. These keywords may have been previously identified by the NLP 282 and provided as tokens to the MLM 284 via the output 283.

The MLMs 284 may generate the action list 285. The action list 285 may contain actions and sub-actions, and an identification of one or more IoT devices that are to be used to undertake those actions. In the given example, two actions may be determined by the MLMs 284. Action 1 may be to “perform laundry wash” which may generally relate to performing a washing of clothes through the use of a washing machine. The washing machine may be an IoT device. To perform this action, multiple sub-actions may be performed. In some examples, each sub-action may belong to a separate IoT device. For example, sub-actions for action 1 may be performed by turning on a water heater. Additional details about the water heater may be generated by the MLM 284 based on the details (e.g., a desired water temperature, how long the water should be heated, etc.). Similarly, sub-action 2 and sub-action 3 of action 1 may both relate to the washing machine IoT device, which may be “pre-wash” and “delay wash.” Action 2 may relate to turning on a basement. Turning on a basement may involve identifying by the MLMs 284 which devices may be in the basement area of a home environment. For example, this may include turning on climate control unit (which may an IoT device) as one sub-action and/or turning on lighting as another sub-action.

Additional details about these actions may be generated by the MLM 284 based on information which may be known by the MLM 284 regarding the specific functionality of the IoT devices. For example, if a particular make, model, software version, maximum usable time, energy consumption limits, wear and tear cycles, etc. are known for a particular IoT device, that information may be used by the MLM 284 in determining the one or more actions. In some examples, time information may also be included in determining a sequence of actions and sub-actions.

In some examples, the MLMs 284 may also be configured to be “edge” models, which are configured to be run solely on the hardware of the computing device (e.g., the computing device 102). These edge models may allow for processing to be performed without any information leaving the local network. Additionally, the MLMs may be stored to not save any former user inputs, which may reduce privacy and/or security risks. As processing may occur entirely locally, without leaving the local network, privacy and security risks may be reduced. Additionally, the MLMs 284 may be configured and/or trained to be computationally suitable for the computing device on which they are executing (e.g., ensuring that the MLMs 284 may perform the analysis within a certain period of time (e.g., within 5 seconds)).

Turning to FIG. 2C, additional aspects of the system 200 and the machine learning service 220 are described. As discussed above, the MLMs 284 may generate the action list 285. The action list 285 may be provided to a control module 286. The control module 286 may be any combination of software and/or hardware which may allow for the generation of one or more control signals (e.g., messages configured to control the actions undertaken by IoT devices). The control module 286 may take the information which is contained in the action list 285 and translate those into instructions that may be interpreted and/or understood by the IoT devices 190-193. The control module 286 may generate one or more control signals, such as a control signal 288 and a control signal 289. The control module 286 may include machine learning models, algorithms, translation functions, etc. to generate the control signals 288-289.

As one example, the control module 286 may be in data communication with a database 287. The control module 286 may use the database 287 to translate the action list 285 into the control signals 288-289. The database 287 may be a database which stores information about the IoT devices which are currently contained within the local network and/or accessible by the computing device running the machine learning service 220 (e.g., the computing device 102). The database 287 may be a time series database in which information about each IoT device added and/or removed from the local network may be represented as a datapoint in time (e.g., Influx DB, Timescale DB, OpenTSDB); a NoSQL database which may be suitable for storing unstructured or semi-structured information about the data, and allowing for multiple types of IoT devices and/or formats to be stored (e.g., MongoDB, Cassandra); a relational database such as one using structured query language (SQL); or an edge database, which may be distributed within one or more devices that are contained within the local network. The database 287 may be updated automatically as an IoT device joins, leaves, or is not available on the local network. In some examples, the database 287 may remove an IoT device which has not been used or has been non-responsive for a certain period of time (e.g., more than 2 weeks). In other examples, additional information about the IoT device, such as responsiveness, software updates, etc. may all be stored in the database 287.

The control signal 288 and the control signal 289 may be signals and/or messages which are generated for respective IoT devices (e.g., IoT device 190, IoT device 192). Each control signal may include information for all actions and/or sub-actions to be undertaken by a particular IoT device. This may further include timestamps for when those actions are to be undertaken.

Each control signal may be configured to be transmitted through a suitable communication interface (e.g., through the communication interface 130) to the respective IoT devices. Each control signal may be delivered to the respective IoT device without the control signals leaving the local network on which the computing device and the IoT devices are present. This may increase the security for the local network. Each control signal may be configured to cause an IoT device to perform an action responsive to receipt of the respective control signal. Each control signal may also contain header or identification information, which may allow for a particular control signal to reach its intended IoT device even through indirect channels, such as peer to peer sharing or mesh network sharing between IoT devices. In some examples, the control signal may be translated into a format understandable by the particular IoT device based on the control module 286 and/or information contained within the database 287. Each control signal may be modularized and/or contain instructions as to how it is to be processed, and what actions to be taken by an IoT device if one or more of the action and/or sub-actions encoded within the control signal cannot be undertaken.

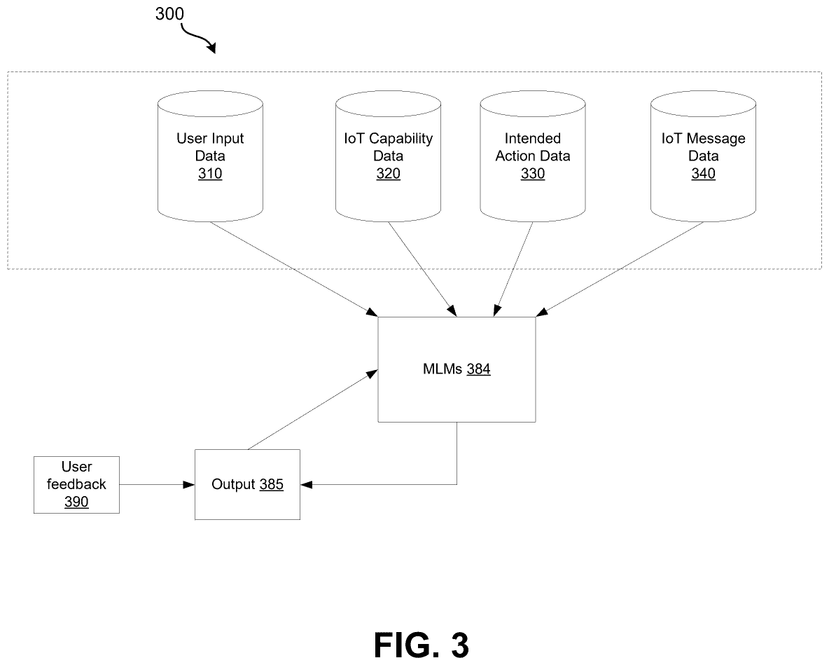

FIG. 3 illustrates aspects of a system 300 which may relate to the training and retraining of MLMs 384. The MLMs 384 may be similar to the MLMs 284. System 300 may include a plurality of databases, such as user input data 310, IoT capability data 320, intended action data 330, and IoT message data 340. MLMs 384 may also provide an output 385, which may be similar to the action list 285. Additionally, a user feedback 390, which may be related to the output 385 (or other related outputs of the MLMs 384 (e.g., the action list 285, the control signals 288-289)) may be used to retrain the MLMs 384 after an initial training process has been completed.

The user input data 310 may include information related to audio and/or voice information which may be received and/or provided by a user (e.g., user input 282, or information related to the user input 282). As the user input may be transformed by one or more services (e.g., the voice analyzer 281 or the NLP 282), the user input data 310 may also include these transformations of the user input 282 (e.g., translations from one language to another, conversion of voice to textual information, tokenization and/or analysis of textual information). The user input data 310 may also include information which is a direct and/or an indirect input to the MLMs 384. For instance, information about how the NLP 282 analyzes and/or tags words, phrases, or information from the voice analyzer 281 may also be included in the user input data 310. In some examples, the configuration of the NLP 282 may also be included as part of the training, retraining, and/or the MLMs 384. The user input data 310 may also include validation data, which may be used to check the output of the MLMs 384, NLP 282, and/or voice analyzer 281.

In some examples, the user input data 310 may be segmented and distributed across multiple machine learning models within the system. Each subset of the user input data can be used to train and refine specific MLMs from the set of MLMs 384. For instance, certain models may be specialized in understanding natural language, while others may focus on interpreting user intentions or recognizing patterns in user behavior. The user input data 310 may contain a set of data related to the NLP 282 and a set of data related to the voice analyzer 281. Segmenting data in this manner may allow for each component to be determined separately.

IoT capability data 320 may be a repository detailing the functionalities, performance characteristics, interaction protocols, and communication methods of various IoT devices (e.g., IoT devices 190-193). In some examples, a list of current IoT devices may be included. This list may encompass a variety of device functions, such as sensors measuring environmental parameters (e.g., thermometers), actuators performing physical actions (e.g., motorized blinds), cameras capturing video, environment control through heating, etc. The IoT capability data 320 may also specify the speed and latency of each device, such as real-time sensors providing immediate readings and high-speed actuators executing commands instantaneously, along with data throughput capabilities. IoT capability data 320 may also describe how devices interact, either directly or through a central hub, and how they may coordinate actions, such as synchronized operations or conditional responses based on other devices' data. Communication protocols may also be included, such as for example, wireless protocols like Wi-Fi, Bluetooth, Zigbee, and Low Power Wide Area (LPWA) networking, as well as wired connections like Ethernet. Additionally, the IoT capability data 320 may categorize devices into logical groupings such as based on functions, locations, or roles, such as environmental sensors, security devices, and environmental equipment. Such groupings may also extend to network-based configurations, and may distinguish between edge devices and cloud-connected devices. Some groupings may also include scenario-based setups like home automation and industrial automation.

The intended action data 330 encompasses the specific actions or outcomes that were intended and correspond to a user input (e.g., within the user input data 310). This may form a part of the outputs for which the MLM 384 is trained (e.g., action list 285). Each data point in intended action data 330 may be a list of all actions and sub-actions for a set of IoT devices that are available and/or present in a particular group. This data may allow for user intentions to be accurately understood and/or executed. The intended action data 330 may include a range of commands, preferences, and desired states for various devices within the IoT ecosystem. The intended action data 330 may include user-specified commands, such as turning on lights, adjusting the thermostat, locking doors, or initiating security protocols. It may also include more complex sequences of actions, like setting a home automation scene that dims the lights, plays music, and adjusts the climate control system simultaneously. The intended action data 330 can be derived from direct user inputs through interfaces like mobile apps, voice commands, or web portals. It may also be inferred from user behavior patterns and preferences that may be learned over time or provided by an expert. In some examples, time information may also be included. For instance, the system can recognize that a user typically lowers the thermostat at night and can automatically include this action. Thus, this information may be associated with an input that corresponds to “prepare the room” or “get ready for bed.” In some examples, in addition to immediate commands, the intended action data 330 can include scheduled actions that are set to occur at specific times or under certain conditions. Examples may include scheduling lights to turn on at sunset, starting a coffee maker in the morning, or activating security cameras when the user leaves home. This data may be used to train the MLMs 384 to interpret user inputs and map them to the appropriate device actions. The intended action data may also include the actions, sub-actions, and other specific control signals that may be outputted by the MLMs 384.

IoT message data 340 may include messages received and/or sent to the IoT devices. It may include error codes. For example, each type of error may be assigned a unique code to facilitate quick identification and reference. These codes may be standardized to ensure consistency across different devices and manufacturers. A device ID may also be included to identify the specific device that encountered the error, enabling targeted troubleshooting. Device status information may also include the current status of the device at the time of the error, including operational state, connectivity status, and recent activity logs.

A combined dataset may be generated based on the user input data 310, IoT capability list, intended action data 330, and the IoT error message data. The combined dataset may also be split into training, validation, and test sets, enabling the iterative refinement of the machine learning model. The training set may include preprocessing and labeling of the training dataset may occur. In the training set, only a subset of data may be useful or of a certain criterion suitable for training may be used to ensure a high-quality training set. A validation dataset may be used to fine tune aspects of the model and to assess the performance of one or more trained MLMs. One or more metrics related to the machine learning models performance may be improved. This process may take place iteratively. In some examples, the model parameters may be adjusted or the choice of training algorithm may be changed. The test dataset may be used to test the model to evaluate its performance (e.g., accuracy, number of false positives, the use of a confusion matrix, etc.).

The MLMs 384 may include any of the following features or methods for training. In some examples, supervised learning models may be used. In this example, models may be trained on a labeled dataset. For instance, each training example for the machine learning model may be paired with an output label. In the training process, the model learns to predict an output from an input set of data. Examples may include linear regression for continuous outputs and logistic regression, support vector machines (SVMs), and neural networks for categorical outputs. Additional examples may include unsupervised learning models. Such models work with unlabeled data. Other models may include clustering models (e.g., k-means, hierarchical clustering) and dimensionality reduction models (e.g., principal component analysis, auto-encoders, etc.). Other examples may include semi-supervised learning processes. This may involve a combination of a small amount of labeled data and a large amount of unlabeled data. The model leverages the labeled data to learn better representations of the unlabeled data, improving its performance.

In some examples, reinforcement learning techniques may be used. In some examples, models may be trained or “learn” to make sequences of decisions by interacting with an environment to achieve a goal. The learning is guided by rewards, where the model seeks to maximize its total reward. Examples include game playing, robotic navigation, and online recommendation systems.

In some examples, additional types of machine learning models, techniques, or training methods may be used. In some examples, a Recurrent Neural Network (RNN) may be used. A Recurrent Neural Network (RNN) is a class of artificial neural networks where connections between nodes form a directed graph along a temporal sequence. This structure allows RNNs to exhibit temporal dynamic behavior and to process sequences of inputs. This makes them particularly suitable for applications where the time aspect of data is useful. RNN architecture involves a layer of neurons that are connected in a loop, allowing information to persist. Variants of the RNN network, including Long Short-Term Memory (LSTM) may be used. LSTM is designed to overcome a problem of a vanishing gradient in RNNs and is capable of achieving learning long-term dependencies. Gated Recurrent Units, which are a simplified version of LSTMs may also be used. GRUs use a different gating mechanism than LSTMs and are effective at capturing long-term dependencies.

Convolutional Neural Networks (CNNs) may be a specialized kind of Deep Neural Networks. CNNs are composed of multiple layers that transform the input volume (such as an image) into an output volume (e.g., class scores) through a series of differentiable operations.

Various MLMs may be employed in as edge AI model. In some examples, each MLM may be selected for its efficiency and compatibility with the constrained computational resources of edge devices. Decision Trees and Support Vector Machines (SVMs) may be utilized for their simplicity and effectiveness in classification tasks. Convolutional Neural Networks (CNNs), despite their complexity, may be optimized in forms such as MobileNet and SqueezeNet to address certain recognition tasks. Recurrent Neural Networks (RNNs) and their Long Short-Term Memory (LSTM) variants cater to sequential data processing, and may be useful for voice recognition applications. To accommodate the limited processing capabilities, models like K-Nearest Neighbors (KNN) and simplified Ensemble Methods, including Random Forests and Gradient Boosting, may be deployed for relatively easy or simple predictive tasks. Additionally, autoencoders may be utilized for anomaly detection. Quantized or Binary Neural Networks may be implemented to reduce the model size and increase inference speed, crucial for real-time applications. The inclusion of federated learning approaches may also further ensure data privacy and minimizes the need for data transmission by allowing decentralized model training across multiple edge devices.

An output from the MLMs 384 may be provided as an output 385. The output 385 may be similar to the action list 285. The output 385 may also be presented in a format which may identify one or more IoT devices and related actions and/or sub-actions. User feedback 390 may be provided to identify the accuracy of the output 385. In some examples, the user feedback 390 may include textual information to allow for more accuracy. For example, if an output related to an initial input “start the wash” indicates that the washing machine is being started rather than the intended dishwasher, this information can be provided via the user feedback 390 as an additional input (e.g., a voice command saying (“I mean the dishwasher”), a selection on a user interface between two icons (e.g., of a fridge or a washing machine), or textual information (typing “wash the clothes.”)

In some examples, the user feedback 390 may also be requested by a trained machine learning model where training may converge to a point where the probability outcomes are similar (e.g., the probability of two outcomes (e.g., the washing machine IoT device versus the dishwasher IoT device) is similar (e.g., within a threshold of an equal probability or less than a threshold difference from one another)). If the particular IoT device cannot be determined, the MLMs 384 (and/or an associated computing system) may be trained to present a prompt for additional user input through a user device to disambiguate the particular IoT device (e.g., do you want to wash the dishes or your clothes?). This additional training may allow for the MLMs to become more accurate over time, allow for personalization of models for a particular user or home environment, and allow for patterns of use of IoT devices to be discovered. The additional prompt can be responded through the user feedback 390.

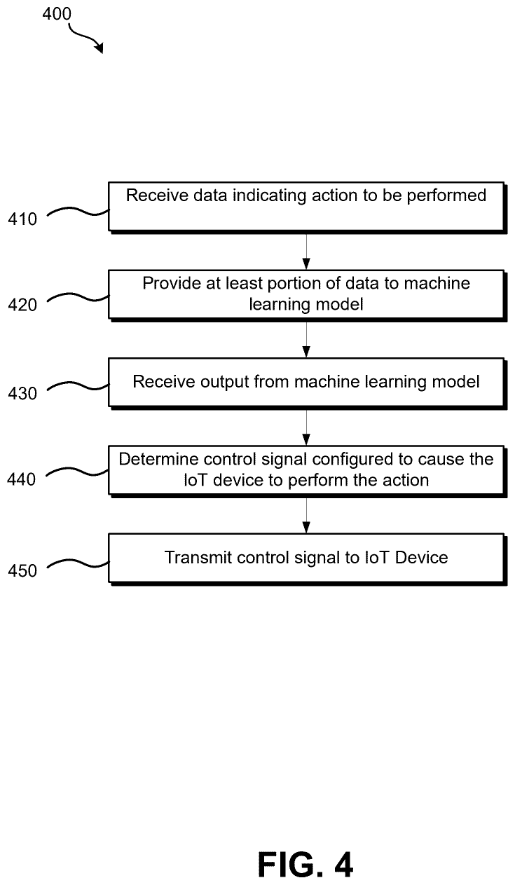

FIG. 4 illustrates a flowchart of a method 400 for detecting objects within an environment, according to certain embodiments. The method 400 may be performed by some or all of the systems and devices described herein. For example, the method 400 may be performed by the systems 100 and/or 200, working alone or in conjunction with each other. The steps of the method 400 may be performed in a different order than is shown and described, and/or some steps may be combined. In some embodiments, some steps may be skipped altogether.

At step 410, the method 400 may include receiving, by a computing device, data indicating an action to be performed. The computing device may be similar to the computing device 102 of FIG. 1. The data may be similar to the user input 132 of FIG. 1. The user input 132 may be provided as textual, visual, or auditory data. The user input 132 may be processed by the computing device. For example, the user input 132 may be processed by the voice analyzer 281 and/or the NLP 282. In some examples, the user input 132 may be provided as textual information which is provided through a keyboard to a user interface of the client device 150 configured to receive user input. This may include for example, a chatbox through which a user can provide a string of text which can be interpreted by the computing device 102. For example, the data may be voice data and/or textual data in which a user states “prepare the basement and start the wash.” In some examples, other input may be used. For instance, a camera may be used to identify certain portions or enhance a user input. For instance, if a user is carrying his or her keys, it is likely that the user is entering or exiting his or her house. As an example, a user may state “It is freezing in here, I need a hot bath!”

At step 420, the method 400 may include providing, by the computing device to a machine learning model, at least a portion of the data. The machine learning model may configured to determine an IoT device associated with the action to be performed using the portion of the data. The machine learning model may be any of the models which may be stored and/or provided by the machine learning service 120. The machine learning model may also be any of the models which may include any combination of the voice analyzer 281, the NLP 282, the MLMs 284 and/or MLMs 384. Prior to receipt of the at least portion of the data, the user input may be transformed using one or more components (e.g., the voice analyzer 281 if audio information is provided, the NLP 282 if textual information is provided, etc.).

Referring to the example above where a user states “it is freezing in here, I need a hot bath!” the data may first be provided to the voice analyzer 281. The voice analyzer 281 may generate text corresponding to the audio and additionally provide context on the pitch and emotion of the audio. In the given example, it may be apparent that the request is urgent, and a “high” emotional context may be associated with the text. Textual information outputted by the voice analyzer 281 may be provided to the NLP 282. The NLP 282 may tokenize the text and also provide other metadata related to the text (e.g., that the urgency is related to the temperature rather than the need to take a bath). The NLP 282 may provide this information to the MLMs 284, which may analyze the information to determine one or more IoT devices associated with the input, and an action to take with respect to the determined one or more IoT devices.

At step 430, the method 400 may include receiving, by computing device from the machine learning model, an output from the machine learning model, the output indicating the IoT device associated with the action to be performed. For example, the output may be similar to the output 283 and/or the action list 285 illustrated with respect to FIGS. 2A-2C. The output may indicate actions and/or subactions to be taken based on the data indicating an action to be performed (e.g., a user voice input). The output of the machine learning model may be of varying complexity based on the intended IoT device(s), the make and model of the IoT device, the number of subactions which need to be taken to perform the intended action. Referring to the example discussed above, the MLMs 284 may determine that the heater should be started, any additional heaters (e.g., space heaters within a room) should be started, curtains should be opened (e.g., if it is sunny outside) or closed (e.g., if it is cold and thermal loss to the outside environment may occur), initiating a water heater, and once the water is heated, opening a tap to fill a bathtub with water. The MLMs 284 may also determine an order in which the actions may be performed (e.g., actions which will correct the temperature prior to initiating the heating of water for a bath).

At step 440, the method 400 may include determining, by the computing device a control signal configured to cause the IoT device to perform the action. The control signal may be similar to the control signal 140, the action list 285, and/or the control signals 288-289. The control signal may include both actions and sub-actions to be performed by the IoT device. Referring to the example provided above, the control signal may be generated for a central heater IoT device, a water heater IoT device, and a bath faucet IoT device. The control signal for the central heater may have a sub-actions such as set temperature to maximum, use the maximum fan speed, override energy efficiency settings, etc. Similarly, the water heater IoT device may have sub-actions such as set temperature to a user defined preference, keep water warm for only 15 minutes, etc.

At step 450, the method 400 may include transmitting, by the computing device, the control signal to the IoT device. For example, the control signal 140 may be transmitted from the computing device 102 to the IoT device 192 as a control signal 140. In some examples, the control signal may be transmitted over a local network. In other examples, a communication interface which may be common between the IoT device intended as the recipient for the control signal and the communication interface of the computing device (e.g., Bluetooth, NFC, etc.). An error message may also be provided when the machine learning model is unable to determine an output. The MLM may also provide one or more options to which user input may be provided. In some examples, additional user input may be provided to resolve an error message based on the one or more options. The machine learning model may be retrained based on the user input.

In some examples, the machine learning model may be configured to be executed locally on the computing device. This may allow for all the user input to be processed and executed locally without the use of a server. The machine learning model may also be retrained based on user feedback which may indicate the accuracy of the output and/or control signals generated by the MLM. The MLM may be retrained or an alternative MLM may be chosen based on the user feedback. In some examples, an MLM may be chosen based on the set of IoT devices which are included and/or associated with the computing device and/or the local network. Sub-actions may be determined by the MLM along with one or more IoT devices to carry out the sub-actions. This information may be outputted by the IoT devices.

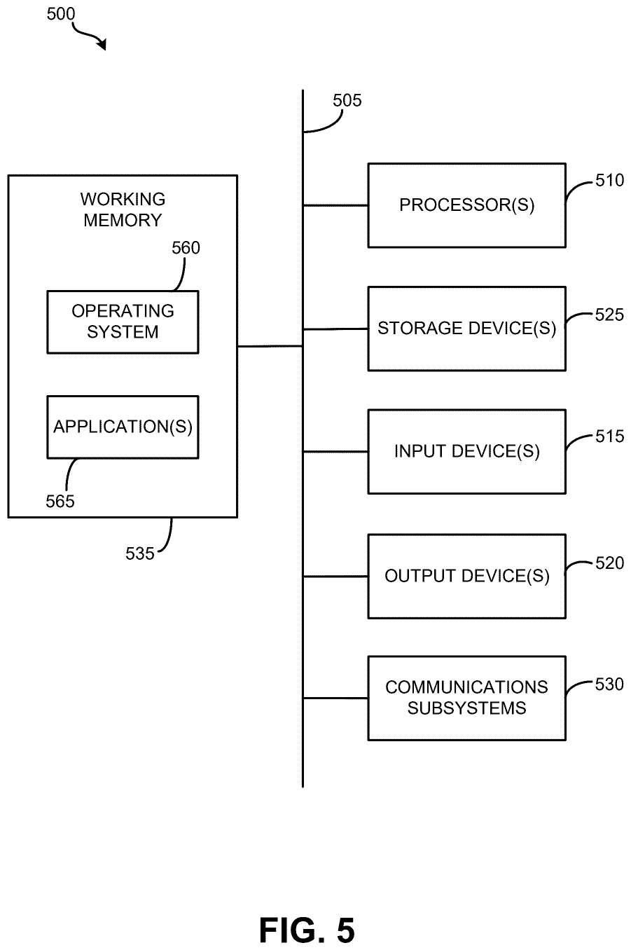

FIG. 5 is a schematic diagram illustrating an example of computer system 500. The computer system 500 is a simplified computer system that can be used to implement various embodiments described and illustrated herein. A computer system 500 as illustrated in FIG. 5 may be incorporated into devices such as a portable electronic device, mobile phone, or other device as described herein. FIG. 5 provides a schematic illustration of one embodiment of a computer system 500 that can perform some or all of the steps of the methods and workflows provided by various embodiments. It should be noted that FIG. 5 is meant only to provide a generalized illustration of various components, any or all of which may be utilized as appropriate. FIG. 5, therefore, broadly illustrates how individual system elements may be implemented in a relatively separated or relatively more integrated manner.

The computer system 500 is shown including hardware elements that can be electrically coupled via a bus 505, or may otherwise be in communication, as appropriate. The hardware elements may include one or more processors 510, including without limitation one or more general-purpose processors and/or one or more special-purpose processors such as digital signal processing chips, graphics acceleration processors, and/or the like; one or more input devices 515, which can include without limitation a mouse, a keyboard, a camera, and/or the like; and one or more output devices 520, which can include without limitation a display device, a printer, and/or the like.

The computer system 500 may further include and/or be in communication with one or more non-transitory storage devices 525, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 500 might also include a communications subsystem 530, which can include without limitation a modem, a network card (wireless or wired), an infrared communication device, a wireless communication device, and/or a chipset such as a Bluetooth™ device, a 802.11 device, a WiFi device, a WiMax device, cellular communication facilities, etc., and/or the like. The communications subsystem 530 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 530. In other embodiments, a portable electronic device, e.g., the first electronic device, may be incorporated into the computer system 500, e.g., an electronic device as an input device 515. In some embodiments, the computer system 500 will further include a working memory 535, which can include a RAM or ROM device, as described above.

The computer system 500 also can include software elements, shown as being currently located within the working memory 535, including an operating system 560, device drivers, executable libraries, and/or other code, such as one or more application programs 565, which may include computer programs provided by various embodiments, and/or may be designed to implement methods, and/or configure systems, provided by other embodiments, as described herein. Merely by way of example, one or more procedures described with respect to the methods discussed above, such as those described in relation to FIG. 5, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 525 described above. In some cases, the storage medium might be incorporated within a computer system, such as computer system 500. In other embodiments, the storage medium might be separate from a computer system e.g., a removable medium, such as a compact disc, and/or provided in an installation package, such that the storage medium can be used to program, configure, and/or adapt a general-purpose computer with the instructions/code stored thereon. These instructions might take the form of executable code, which is executable by the computer system 500 and/or might take the form of source and/or installable code, which, upon compilation and/or installation on the computer system 500 e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 500 to perform methods in accordance with various embodiments of the technology. According to a set of embodiments, some or all of the operations of such methods are performed by the computer system 500 in response to processor 510 executing one or more sequences of one or more instructions, which might be incorporated into the operating system 560 and/or other code, such as an application program 565, contained in the working memory 535. Such instructions may be read into the working memory 535 from another computer-readable medium, such as one or more of the storage device(s) 525. Merely by way of example, execution of the sequences of instructions contained in the working memory 535 might cause the processor(s) 510 to perform one or more procedures of the methods described herein. Additionally, or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 500, various computer-readable media might be involved in providing instructions/code to processor(s) 510 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 525. Volatile media include, without limitation, dynamic memory, such as the working memory 535.

Common forms of physical and/or tangible computer-readable media include, for example, a floppy disk, a flexible disk, hard disk, magnetic tape, or any a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 500.

The communications subsystem 530 and/or components thereof generally will receive signals, and the bus 505 then might carry the signals and/or the data, instructions, etc. carried by the signals to the working memory 535, from which the processor(s) 510 retrieves and executes the instructions. The instructions received by the working memory 535 may optionally be stored on a non-transitory storage device 525 either before or after execution by the processor(s) 510.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein and in the appended claims, the singular forms “a”, “an”, and “the” include plural references unless the context clearly dictates otherwise. Thus, for example, reference to “a user” includes a plurality of such users, and reference to “the processor” includes reference to one or more processors and equivalents thereof known in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

What is claimed is:

1. A method for controlling an Internet of Things (IoT) device, the method comprising:
receiving, by a computing device, data indicating an action to be performed;
providing, by the computing device to a machine learning model, at least a portion of the data, the machine learning model configured to determine an IoT device associated with the action to be performed using the portion of the data;
receiving, by computing device from the machine learning model, an output from the machine learning model, the output indicating the IoT device associated with the action to be performed;
determining, by the computing device a control signal configured to cause the IoT device to perform the action; and
transmitting, by the computing device, the control signal to the IoT device.

2. The method of claim 1, wherein the machine learning model is executed locally on the computing device.

3. The method of claim 1, wherein the determining the control signal is performed by the machine learning model.

4. The method of claim 1, wherein the machine learning model is executed on a remote server.

5. The method of claim 1, further comprising:
receiving, by the computing device, user feedback indicating an accuracy of the output; and
providing, by the computing device, at least one of the output or the use feedback such that the machine learning model is retrained.

6. The method of claim 5, wherein the user feedback is provided to a server and the retraining occurs at the server.

7. The method of claim 1, further comprising:
detecting, by the computing device, a change associated with the IoT device or additional IoT devices;
transmitting, by the computing device, data indicating the change to a server;
receiving by the computing device, a training data from the server, the training data associated with the change; and
providing, by the computing device, the training data to the machine learning model such that the machine learning model is retrained.

8. The method of claim 1, further comprising:
determining, by the machine learning model of the computing device, one or more sub-actions related to the action to be performed;
determining, by the machine learning model, the IoT device or additional IoT devices associated with the one or more sub-actions; and
generating, by the machine learning model, the output to indicate the IoT device or the additional IoT devices.

9. The method of claim 8, further comprising:
for each of the IoT device or the additional IoT devices indicated in the output:
determining, by the computing device, a respective control signal configured to cause a respective IoT device to perform an associated sub-actions; and
transmitting, by the computing device, the respective control signals to the respective IoT devices.

10. The method of claim 1, further comprising:
receiving, by the computing device, a status update from the IoT device after executing the action; and
causing, by the computing device, a confirmation or result of the action to be displayed.

11. The method of claim 1, further comprising, retraining the machine learning model based on receiving, at the computing device, a new capability of the IoT device.

12. The method of claim 1, wherein data indicating the action to be performed is a voice command.

13. A non-transitory computer-readable medium containing instructions, that when executed by one or more processors, are configured to cause the one or more processors to perform operations comprising:
receiving, by a computing device, data indicating an action to be performed;
providing, by the computing device to a machine learning model, at least a portion of the data, the machine learning model configured to determine an IoT device associated with the action to be performed using the portion of the data;
receiving, by computing device from the machine learning model, an output from the machine learning model, the output indicating the IoT device associated with the action to be performed;
determining, by the computing device a control signal configured to cause the IoT device to perform the action; and
transmitting, by the computing device, the control signal to the IoT device.

14. The non-transitory computer-readable medium containing instructions of claim 13, wherein the machine learning model is executed on a remote server.

15. The non-transitory computer-readable medium containing instructions of claim 13, further comprising:
receiving, by the computing device, user feedback indicating an accuracy of the output; and
providing, by the computing device, at least one of the output or the use feedback such that the machine learning model is retrained.

16. A system comprising:
one or more processors; and
a computer readable medium comprising instructions that, when executed by the one or more processors, cause the system to perform operations to:
receive, by a computing device, data indicating an action to be performed;
provide, by the computing device to a machine learning model, at least a portion of the data, the machine learning model configured to determine an IoT device associated with the action to be performed using the portion of the data;
receive, by computing device from the machine learning model, an output from the machine learning model, the output indicating the IoT device associated with the action to be performed;
determine, by the computing device a control signal configured to cause the IoT device to perform the action; and
transmit, by the computing device, the control signal to the IoT device.

17. The system of claim 16 further comprising instructions that when executed cause the system to perform operations to display an error message when the machine learning model is unable to determine the output.

18. The system of claim 17 further comprising instructions that when executed cause the system to perform operations to display, one or more options displayed, the one or more options indicating user inputs to resolve the error message.

19. The system of claim 18, further comprising instructions that when executed cause the system to perform operations to receive at least one user input responsive to the one or more options to resolve the error message.

20. The system of claim 19, further comprising, further comprising instructions that when executed cause the system to perform operations to retrain the machine learning model based on the user input responsive to the one or more options to resolve the error message.
